(19) United States
(12) Patent Application Publication
(10) Pub. No.: US 2007/0255603 A1
(43) Pub. Date: Nov. 1, 2007

(54) System for Sale of Entrance Tickets

(75) Inventors: Jiri Hosnedl, Praha (CZ); Jiri Meizner, Praha (CZ)

Correspondence Address: BIRCH STEWART KOLASCH & BIRCH, PO BOX 747, FALLS CHURCH, VA, 22040-0747, US

(73) Assignee: SAKA, a.s., Praha (CZ)

(21) Appl. No.: 11/663,828

(22) PCT Filed: Apr. 8, 2005
(86) PCT No.: PCT/CZ05/00033

§ 371 Date: Jun. 21, 2007

(30) Foreign Application Priority Data
Oct. 1, 2004 (CZ) PUV2004-15868

(51) Int. Cl. G06Q 10/00

(52) U.S. Cl. 705/5

(57) ABSTRACT

A system for sale of entrance tickets comprising a database server (6) to which a switch (4), a firewall (3) and another switch (2) are connected, a routing device (1) being connected to the second mentioned switch (2) for connecting an Internet link of an Internet provider, a database server (6) being connected by means of a switch (2,4) to single sale channels, these channels being represented by box-office terminals (11) of the box-offices sale channel in the locality of undertaking, further by a server (5) of a sale channel for entrance tickets by means of lottery terminals of a central lottery system, further by a sale channel of entrance tickets through a call center (12), further by a routing device (10) for connecting a net of vendors of a sale channel, the channel being formed by a net of specialized vendors, the database server (6) being also connected to a server (7) of a sale channel through Internet, further it is connected to a specialized work place (13) for distribution of entrance tickets so as to an administration (15) of the ticketing sale system, an information system (9) and a server (8) for administration of firewall and of switches.

### FIELD OF ART

The invention concerns a system for sale of entrance tickets.

### STATE OF ART

Known devices for the sale of entrance tickets are drafted as independent entrance tickets sale systems and it is necessary to use a special terminal (PC) for them. The object of the invention is therefore to provide a system for sale of entrance tickets which makes possible to join more sale channels into one unit, to form one integral unit with a ticketing system.

### OBJECT OF INVENTION

The mentioned disadvantages are removed by the inventive entrance ticketing sale system which comprises a database server to which a switch, a firewall and a further switch are connected, a routing device for connecting an internet link of an Internet provider being connected to said further switch, the database server being connected by means of a switch to single sale channels, i.e. box-office terminals of the box-office channel situated at the locality where the undertaking takes place, further a server of the sale channel for sale of tickets by means of lottery terminals of a central lottery system, further a sale channel of the entrance ticketing system through so called call center, further a routing device for connecting a net of vendors of a sale channel formed by a net of specialized sale agents and to the server of an Internet sale channel, further the system is connected to a specialized workplace of distribution of entrance tickets so as to an administration of the whole ticketing sale system, to an information system and to a server for the administration of the firewall and of the switches.

The entrance ticketing sale system, advantageously as a payment channel of a sale Internet channel includes a lottery terminal of a central lottery system.

A further advantageous embodiment of the entrance ticketing sale system for a sale channel by means of lottery terminals includes means for the choice of place using strategy place numbers.

A further advantageous embodiment of the entrance ticketing sale system for a sale box-offices channel includes means for checking entrances to the locality of undertaking.

An advantage of the ticketing sale system according to the invention is an integration of more different sale channels. The main advantage is the possibility to use the lottery terminals net. The distribution of entrance tickets on this net represents an added value which valorizes this net without any further high additional costs. The method for ticket payments booked by Internet by means of the local lottery terminals net is advantageous as the customer can choose by the comfortable environment of Internet the desired places and desired entrance tickets which are then paid by this trustworthy and comfortable method using the terminal staff. A further advantage is the method to choose the entrance ticket by means of a strategy number when, according to the kind of performance and to the arrangement of the locality of undertaking, a unique “strategy number” is coordinated in advance to each place which defines the seating quality. This is used for the choice of the seat by means of the lottery terminal when always the best actually available place (or a best group of places) is offered to the betting person. An advantage of the sale channel for entrance tickets by means of a direct sale through a box-office or box-offices in the locality of undertaking, e.g. in a hall, is the possibility to check the entrances by means of sending the information concerning the entrance tickets with permitted or forbidden entrances.

### SUMMARY OF DRAWINGS

FIG. 1 concerns a plugging diagram of the entrance tickets sale system and FIG. 2 represents a connection of the central part of the ticketing sale system to the sale channels, an information system and further cooperating systems and work-places.

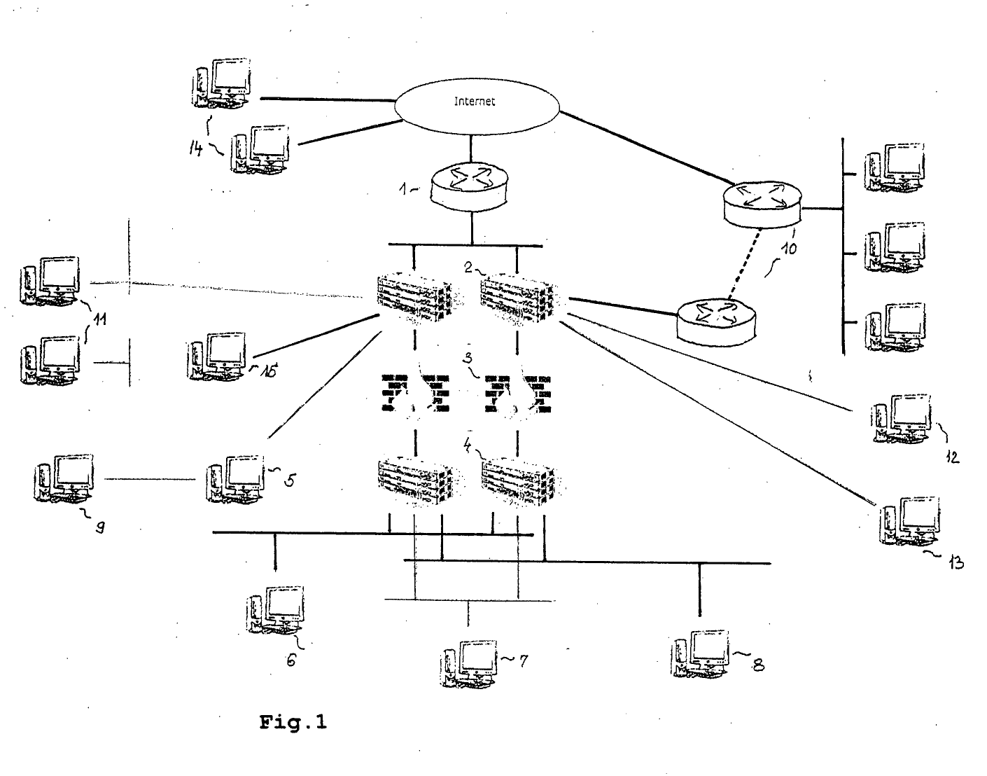

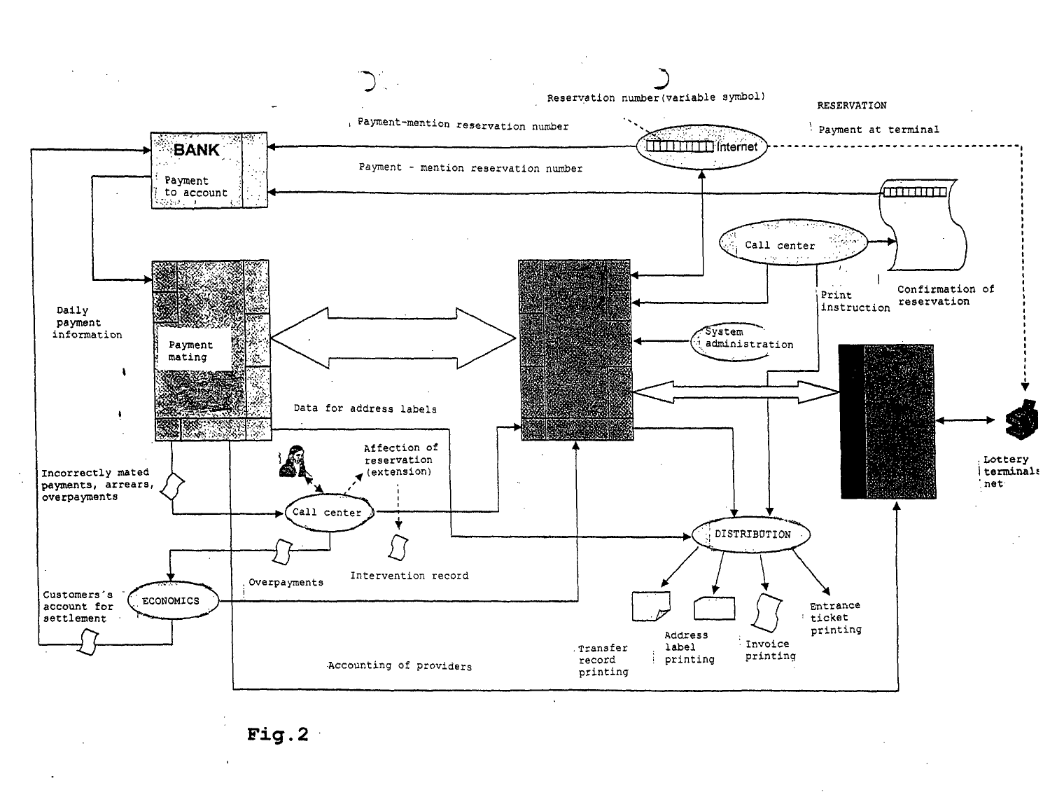

### EXAMPLES OF INVENTIVE EMBODIMENTS

The system of the entrance tickets sale system according to the invention will be explained by using examples of inventive embodiments with references to the attached drawings. The heart of the ticketing sale system is formed by its central part and single sale channels connected to it, an information system and further cooperating systems and specialized work-places so as the administration of the whole system.

The central part is equipped by single interfaces which make possible to connect the central part to single distribution sale channels, to the information system and to further cooperating systems and specialized work-places taking part on the activity of the entrance tickets sale system.

The heart of the entrance tickets sale system is formed by a database server 6 for storing of information concerning the pertinent entrance tickets to the relevant undertaking, i.e. to relevant performances or matches.

A switch 4, a firewall 3 and a switch 2 is connected to the database server 6. The switches 2,4 serve for interconnection of single parts of the ticketing sale system, the firewall 3 is intended for a safe separation from the Internet environment. A routing device 1 is connected to the switch 2 to connect the Internet link of the Internet provider.

A server 7 of the sale Internet channel is connected to the switch 4. Individual customers use this channel for the admission to the ticketing sale system by means of terminal devices 14. A server 8 for the administration of the firewall and of the switches is connected to the switch 4, the server 8 being intended also for the setup configuration of the firewall and of the switches.

A server 5 of the ticketing sale channel by means of lottery terminals of a central lottery system is connected to the switch 2 and also a routing device 10 for connecting the vendors net of the sale channel, the channel being formed by a net of specialized vendors. Also single box-office terminals 11 of the box-offices sale channel in the locality of undertaking are connected to the switch 2 so as a sale channel of the sale ticketing system through so called call center 12 and a specialized work-place 13 of the entrance tickets distribution. Also an administration 15 of the whole ticketing sale system and an information system 9 are connected to it. The administration 15 of the system controls the opening and the closing of sales for all sale channels, the definition of places for sale in single channels, the preparation of sale openings of new undertakings, forming of new configurations of a locality of undertaking, e.g. halls, or connections of further localities or halls.

The customer's communication during the Internet sale with a sale application by means of this sale channel is led through the web interface of an Internet browser. The customer communicates through the terminal device 14 and the routing device 1 with the server 7. This server 7 composes then queries for the database 6 of the ticketing sale system using the requests of the customer and sends answers to the customer which are presented to him by means of his browser.

A fundamental premise for sales by means of this channel is that the customer is registered in the database part of the ticketing sale system. This registration is realized by filling-up and by confirmation of a special registration form, by a subscriber table. A reservation process precedes the actual sale when the customer enters his order in a visualized environment of a sale application and defines the payment channel for the settlement of the order. The reservation is realized in the database part of the system by means of entering the order using the visualization of available places, the desired match/performance, the price and the places being chosen direct by the customer using the offer of available places directly in the visualized environment of the sale application, by means of Internet pages. The reservation is preset for the interval of one calendar day. A record of the place available/occupied or reserved is executed in the moment of the reservation. The payment channel can be chosen as a payment by a transfer order and a payment through the lottery terminal. The sale process is accomplished by the customer's payment of the order through the chosen payment channel after accepting the payment in the information system 9 and after mating the payments when the registration or confirmation of registered data concerning the customer's order and the distribution of the entrance ticket is executed. After the payment of the entrance ticket is the state of the seat changed from “reserved” to “paid”.

One possibility of this Internet sale of entrance tickets is a combination of an Internet order with the payment and distribution of tickets by means of a lottery terminal of the central lottery system. The customer chooses by means of Internet pages the desired match/performance, the ticket price and the place in the auditorium. When he chooses the payment by means of the lottery terminal, a 12-digits number of the order is generated for him. Also generating and printing of this number in the form of bar code is possible. The customer brings this number to the local lottery terminal. He fills out the 12-digits number into the entrance ticket form or he brings the printed bar code with him. The entrance ticket form or the bar code is scanned by means of a scanner of the lottery terminal and after paying the order by the customer directly to the lottery terminal attendant, the payment is entered to account and the state of the pertinent seat is changed from “reserved” to “paid” and the entrance tickets are printed for the customer according to his order. The entrance tickets are printed either by a dot matrix printer of the terminal or by a thermal printer, nevertheless printing can be also executed on specialized entrance ticket printer connected to the terminal. An advantage of this sale is that the customer has no distrust of the Internet payment and that the danger of misuse is eliminated. The payment is executed in personal contact with the terminal attendance and money is given to a trustworthy company, the risk that the customer can lose his money being so eliminated.

Another realization possibility of entrance ticket sale instead of printing the ticket is the possibility to send the bar code from the central part of the system to the GSM-operator where the bar code will be encoded into a two-dimensional code which will comprise all data necessary for the entrance to the ordered undertaking and which will be then sent in the form of an image-SMS to the customer's mobile telephone display. The customer comes then to the undertaking where the SMS will be scanned by a turnstile scanner and the customer can enter to the undertaking.

Another possibility of payment is to settle the order through a bank account. The information concerning the reservation and the registration data of the customer are transferred from the central database part of the sale system into the information system 9 and after mating the payment with the order, this information is transferred to the central database part of the system, the state of the reserved places being there automatically changed to “paid”. These orders come so into the queue (group) of paid orders designed for ticket printing and for distribution in a specialized work-place 13 for the ticket distribution. During the distribution, an address label, an invoice, a transfer record and a mailing certificate are printed, too.

Each sale from this distribution channel and also from each other channel is immediately on-line recorded into the central database part of the entrance ticketing sale system.

Another sale channel is a sale channel for the sale of tickets by means of lottery terminals of the central lottery system, this central lottery system being used for the communication between the customer and the entrance ticketing sale system. This lottery system is formed by local interactive lottery terminals itemized into single groups of clusters belonging to single playing localities where a local checking unit forms a part of each group. A central checking device accessible to each playing terminal through the regional communication net is also a part of each group.

The sale of the entrance tickets by means of the lottery terminal is realized in three steps. In the first step, the customer is informed by printouts issued by the lottery terminal printer what undertakings take place and what identification numbers they have. In the second step, the customer executes the reservation of a place or places concerning the ordered undertaking, the customer gives the filled-out entrance ticket form with an identification number of undertaking to the terminal attendant, the attendant inserts the form into the terminal and the terminal informs if some places concerning the desired undertaking are available and what is the price of such places. The communication is executed through the central lottery system which communicates by means of an approved record with the central part of the ticketing sale system. The terminal attendance then enters the desired number of entrance tickets lying in the desired price category according to the customer's wish and choice, the customer obtaining then a proposal of the entrance ticket comprising the place offer. This proposal is executed by means of an algorithm for the choice of the best available place realized in the central database of the ticketing sale system. The system works on the base of strategy numbers where each place in the seating schedule of the hall, i.e. a schedule of place layouts related to their advantageousness, price category and type of place, concerning the desired undertaking, has a unique strategy number. This number expresses the quality of seat and always defines what seat is better than another one. It is possible to enter for each match or performance another strategy number concerning the same seat (each seat has different quality or array if a hockey match takes place or a concert). When the customer wishes to obtain more places, e.g. three, the system offers three adjacent places with the lowest sum of their strategy numbers. The reservation made by this method has a limited validity, e.g. 15 minutes—it represents one parameter of the system—and the customer can decide during the validity of the reservation if he accepts the offer of places or if he refuses such offer. After the acceptance of the offer by the customer, the sale of the entrance ticket is realized by the confirmation of data from the ticket proposal by means of the lottery terminal into the central part of the ticketing sale system. After the confirmation of the 20-digits reservation number of the ticket proposal to the central database of the ticketing sale system is the state of the pertinent seat changed in “sold”. Then customer obtains then entrance tickets printed by the lottery terminal printer, these tickets being immediately paid cash by the customer.

When the payment is executed by means of the lottery terminal, the accounting of the entrance tickets contains also the accounting of providers by means of sending electronic evidences from the information system 9 for the money delivery, the survey of earnings, winnings, rewards for single sales being included, see FIG. 2.

Another sale channel is an entrance tickets sale channel by means of an ordering center, a call center 12. This sale channel makes possible that entrance tickets are sold to the customers by means of a telephone and e-mail communication. The customer communicates with the channel operator attending the terminal (PC) connected to the central part of the ticketing sale system. The sale channel is designed only for the acceptance of collective orders from wholesale customers.

The sale is executed again in more steps. The first step concerns the registration of the customer into the central part of the ticketing sale system by means of inserting the customer's contact data by the operator, the reservation of the entrance tickets being executed by entering the order data directly in the central database of the ticketing system by changing the seat state from “available” to “reserved”, the payment method by a bank transfer being simultaneously mentioned. The operator communicates with the sale application by means of a terminal (PC) with a web interface. The second step contains a payment excerpt from the information system 9 after mating the payments and reservation under a pertinent variable symbol concerning the reservation number, the entrance tickets being made available for distribution to the customer after payment. It is necessary, in order to mate the payments during the payment process, to mention the reservation number which serves for mating single payments, as it must be evident what reservation is concerned by a respective payment—see Payment—mentioning the reservation number, FIG. 2. All necessary data, the sum, the variable symbol, data concerning the customer, are by means of interface files transferred to the information system 9 where also data concerning the details of incoming payments to the bank account are transferred. The mating of payments is made there. If no mating of a payment is executed (if the sum sent by the customer does not match with the necessary sum), the information system 9 forms a special composition of incorrectly mated payments and, using this composition, the customers are contacted in order to match the sum with the requirement, or alternatively to modify pertinently their reservation. The distribution of entrance tickets is then executed to the customer by means of a specialized work place 13 by mailing.

By means of this sale channel also the already executed orders can be operatively changed or it is possible to contact the customers who did not execute the correct payment for their reservation—when they have sent little money or excess money.

Another sale channel is an entrance tickets sale channel by means of a net of specialized vendors, i.e. a net of contractual juridical or physical persons who execute the sales directly from the central part of the ticketing sale system. The sale of tickets is in this sale channel realized by means of an operator's terminal (PC) connected to the central part of the Internet ticketing sale system. A routing device 10 serves to aim the requirements from this net of specialized vendors to Internet, the specialized vendor being through Interned connected to the central part of the ticketing sale system. The operator communicates with the sales application through a web interface in the same way as in the case with a call center. Nevertheless, the sale of entrance tickets and the payment are executed in one step using cash payment or payment with a payment card directly in the vending place. The customer obtains immediately an entrance ticket printed by a thermal ticket printer on a special thermopaper.

The last sale channel is a ticketing sale channel by means of a direct sale using a box-office or box-offices in the locality where the undertaking takes place, e.g. in a hall. In this case, the entrance tickets are sold usually on the day when the undertaking takes place. The sale of entrance tickets by means of this sale channel is realized equally as at the specialized external vendors. The customer pays to the attendant cash or by a payment card. The advantage of this sale is that it is possible to check entrances into the building where the undertaking takes place, e.g. into a hall, this being made by means of sending the information concerning the entrance tickets with approved or rejected entrance and by means of their scanning by a turnstile scanner.

1. A system for sale of entrance tickets comprising sale channels, at the outer end of these sale channels communication means being arranged and the second ends of these channels being introduced into the center of the system, characterized in that the system comprises a database server (6) to which a switch (4), a firewall (3) and another switch (2) are connected, a routing device (1) being connected to the second mentioned switch (2) for connecting an Internet link of an Internet provider, a database server (6) being connected by means of a switch (2,4) to single sale channels, these channels being represented by box-office terminals (11) of the box-offices sale channel in the locality of undertaking, further by a server (5) of a sale channel for entrance tickets by means of lottery terminals of a central lottery system, further by a sale channel of entrance tickets through a call center (12), further by a routing device (10) for connecting a net of vendors of a sale channel, the channel being formed by a net of specialized vendors, the database server (6) being also connected to a server (7) of a sale channel through Internet, further it is connected to a specialized work place (13) for distribution of entrance tickets so as to an administration (15) of the ticketing sale system, an information system (9) and a server (8) for administration of firewall and of switches.

2. A system for sale of entrance tickets according to claim 1, characterized in that a lottery terminal of a central lottery system is the payment channel of the sale channel through Internet.

3. A system for sale of entrance tickets according to claim 1 or 2, characterized in that the sale channel by means of lottery terminals comprises means for the choice of a place on the base of strategy numbers of places.

4. A system for sale of entrance tickets according to some of claim 1 or 2, characterized in that the sale channel of box-offices comprises means for checking entrances into the place of undertaking.
